(19) United States
(12) Patent Application Publication
(10) Pub. No.: US 2002/0099573 A1
(43) Pub. Date: Jul. 25, 2002

(54) Network solution system of analysis and evaluation

(75) Inventors: Masanari Koguchi, Kunitachi (JP); Ruriko Tsuneta, Fuchu (JP); Koji Aramaki, Tokyo (JP); Kaoru Umemura, Musashino (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/046,972

(22) Filed: Jan. 17, 2002

(30) Foreign Application Priority Data
Jan. 24, 2001 (JP) 2001-015191
Dec. 3, 2001 (JP) 2001-368213

(51) Int. Cl. G06F 17/60

(52) U.S. Cl. 705/3

(57) ABSTRACT

The present invention provides a solution business for serving high speed and diversified analysis work/result and apparatus maintenance, and provides a function to control the apparatus of a customer and analysis organization with a common command through a network. The analysis organization provides the work involving high level operation and apparatus maintenance, and the interpretation and analysis of the acquired data. The customer participates to the analysis work on line through the video conference. The charge system corresponding to the analysis apparatus and operation content is set in a host computer of the network, the charge is presented to the customer on line as the analysis work proceeds, and the final cost is collected through a bank. Furthermore, the host computer is provided with a library function that stores the past data and literatures for viewing.

### BACKGROUND OF THE INVENTION

The present invention relates to a sample analysis technique, and more particularly relates to a sample analysis technique and a sample analysis system for analyzing a sample through a network.

The conventional analysis evaluation business involves the following processes. At first, a customer sends a sample and specification to an analysis organization, and an analysis expert analyzes the sample to obtain the result. The resultant data is sent to the customer by mail or email when the result is obtained. In the case that a customer has an analyzer, an analysis expert visits the laboratory of the customer to analyze a sample and collect the data.

On the other hand, some techniques for controlling an analysis apparatus from the outside through the Internet have been provided already to the market. For example, the remote operation of an ultra high voltage electron microscope of Osaka University through a network is disclosed in “55th Academic Conference Preliminary Report of Japan Electron Microscope Association” (pp. 181-182, 1999), this report is a typical example. In this example, one more additional set of operation console for operating the electron microscope is installed on the customer side. The operation console of the customer is connected to the electron microscope through the Internet, and the customer can operate the electron microscope remotely. Furthermore, television cameras and monitors are installed on both sites respectively so that the customer can operate the electron microscope with communication between an expert and an operator of the customer as in the case of video conference.

Because the equipment has become large-sized and expensive, the equipment investment and equipment maintenance cost are loaded severely on a customer who wants to buy various analysis apparatus, and further cultivation and maintenance of skilled operator require significant time and cost. Furthermore, the high level operation technique has been required, and the cultivation of special expert for not only analysis technique but also sample preparation and pre-treatment requires significant time and cost.

In some cases, a customer sends a sample for asking analysis of the sample to an analysis organization to save such expense. In the case that the customer locates far from an analysis organization physically, that is the popular case, the customer is required to visit the analysis organization. Visiting to the analysis organization loads the temporal limitation on the analysis staff, and the equipment is not always used when the equipment is in good condition.

Furthermore, the result data is sent to the customer when the analysis result is obtained, at that time additional analysis happens to be requested in many cases. In such case, the communication of result data and discussion on additional request require much time, and it takes a long time to obtain the final useful information.

On the other hand, in many cases, though a customer has many excellent equipments, the customer cannot keep an expert staff on the reason of the necessary cost and time requirements. In such case, it is an another way in which a customer asks an analysis expert to visit the customer for analysis and operation, but the time limitation and cost are loaded heavily on the customer, the customer cannot do that so often and cannot have the expert service immediately when it is needed. Furthermore, a customer must manage the equipment operation (operation and maintenance) while an expert is not there.

Furthermore, with increasing trend of sophistication of the data and diversification of the data, it becomes difficult to interpret the data. On this reason, a customer who is not skilled in the analysis cannot derive the sufficient information from the obtained data.

### SUMMARY OF THE INVENTION

In view of the above, the present invention provides a network solution analysis method and an analysis system for serving quick and diversified analysis work, analysis result, and equipment operation in the sample analysis field.

To solve the above-mentioned problems, at first the analysis apparatus and equipment, a sample analysis organization who employs experts for sample analysis (analysis staff) including the apparatus and equipment operation, and a customer are connected with a network through a communication line. Herein, an analysis staff of the sample analysis organization communicates with a customer each other on video conference in real time for proceeding analysis work. Depending on the case, a customer controls the analysis apparatus and equipment remotely. Furthermore, the analysis staff gives an intellectual expert service that is required for maintenance and apparatus operation.

Furthermore, by storing the obtained data and analysis examples in the past in the database, the analysis organization can give an analysis and interpretation to the data obtained by a customer. The charge system has been established based on the time required for analysis and work, difficulty of operation, and the degree of added value previously, the charge is calculated automatically by means of charge calculation function connected to the network, the charge that is to be charged to the customer is transmitted on line to the customer on an operation screen, and the customer constructs an operation request menu with consideration of the accumulated charge.

Accordingly, a customer can understand the changing charge correspondingly to the analysis and work content immediately, and can examine the request content for the final order. Finally, a bank that received the charge information from the analysis organization requests the charge to the customer and collects the charge from the customer. The equipment, operation special technique, and data analysis technique are used commonly by use of the system of the present invention, and the analysis cost and time required for the analysis is reduced.

### BRIEF DESCRIPTION OF THE DRAWINGS

FIG. 1 is a diagram for describing Embodiment 1 of the present invention.

FIG. 2 is a flowchart showing the sequence for realizing the business model shown in FIG. 1.

FIG. 3 is a diagram for describing Embodiment 3 of the present invention.

FIG. 4 is a flowchart showing a sequence for realizing the business model shown in FIG. 3.

FIG. 5 is a diagram showing one example of an operation screen for supporting the remote operation for carrying out analysis work.

FIG. 6 is a diagram showing the diffraction that occurs when an electron beam transmits through a specimen.

FIG. 7 is a cross sectional view showing a semiconductor device used in Embodiment 5 of the present invention.

FIG. 8 is a diagram showing one example of a display in Embodiment 5 of the present invention.

FIG. 9 is a flow chart for obtaining the stress distribution in Embodiment 5 of the present invention.

FIG. 10 is a flow chart for obtaining the stress distribution in Embodiment 5 of the present invention.

### DETAILED DESCRIPTION OF THE PREFERRED EMBODIMENTS

Embodiments of the present invention will be described in detail hereinafter with reference to the drawings.

Embodiment 1

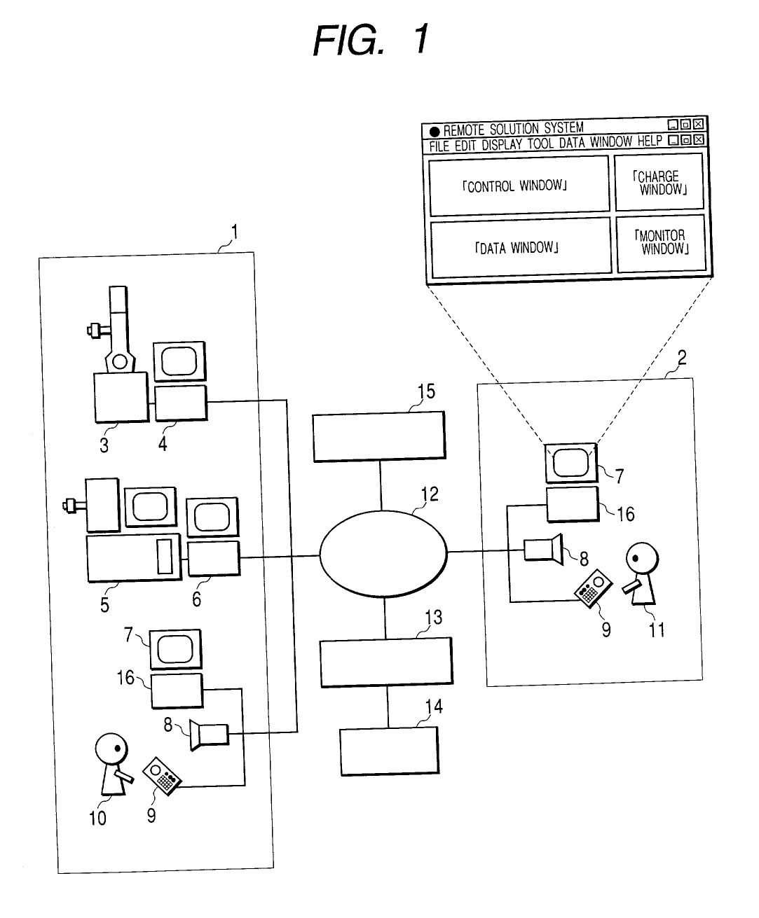

FIG. 1 shows one exemplary business model provided with one analysis organization 1 having various apparatus and a customer 2 connected each other through a network 12 served for carrying out analysis by means of remote operation.

An analysis apparatus, analysis staff 10, a customer 11 are connected through the network 12, cameras 8 and microphones are provided on both sides, and the analysis work is carried out with discussion on video conference by use of a monitor 7 and network computer 16. Herein, A denotes an analysis apparatus 3 and B denotes an analysis apparatus 5. These apparatus include, for example, various physical analysis apparatus and semiconductor inspection apparatus such as an electron microscope, a mass spectrometer, a photoelectron spectrometer, a probe microscope, an Auger spectrometer, and a magnetic resonance spectrometer, various chemical analysis apparatus and biochemical inspection apparatus such as a chromatography, DNA sequencer, and a blood analysis apparatus, various specimen preparation apparatus and pretreatment apparatus such as a convergent ion irradiation apparatus and a plasma cleaner, various image/data processing apparatus such as a personal computer and a scanner, and a library function that stores past data such as a hard disk, and thus an integrated characterization is realized. These apparatus that are controlled by means of a personal computer are commercialized and available in the market.

Therefore, a control PC 4 for A analysis apparatus, a control PC 6 for B analysis apparatus, and the network computer 16 are connected by the network system 12, and the connected system allows us to operate the analysis apparatus from the outside by text-transmitting the command that is common for these components. Herein, the term “apparatus control” includes putting into an apparatus and taking out from an apparatus of a specimen, vacuum exhaust, beaming and preconditioning/optical axis adjustment, focus correction, astigmatism correction, slight specimen movement and inclination, projection, storage and print out of projected data. The console 9 used for controlling the apparatus is provided with buttons and knobs served for preferential functions that are operated easily and used frequently such as button for micro movement mechanism and focusing mechanism of a specimen stage used when a field of view is found and data collection starting button, and the efficient analysis is realized by applying simple operations.

These apparatus can be controlled by use of an operation network system 12 other than the network computer 16, and can be also controlled by use of, for example, a touch panel type control screen prepared on the network computer screen. In the former case, it is required that a network system has been sent previously to the customer. On the other hand in the case of the latter, the operation screen is software, only it is required that a recording medium such as a floppy disk is sent previously or the software has been sent previously to the customer through the network together with an installer. The latter case is easy. Furthermore, because the operation content is different depending on the analysis apparatus to be used, it is required to send a different network system or software. In the case of the software, a method in which “operation screen” portion, which will be described in Embodiment 2, is provided for each analysis apparatus and the operation screen is called out before operation is employed.

Herein, for example, the use of a plurality of analysis apparatus will be described. A method in which defective portions on a wafer or chip are sought by means of a semiconductor inspection apparatus and convergent ion irradiation apparatus, and a defective portion is found and worked by means of the convergent ion irradiation apparatus and observed by means of the electron microscope may be employed. The semiconductor inspection apparatus and the convergent ion irradiation apparatus use the coordinate data commonly for each bit. Thereby, the defective point found by the semiconductor inspection apparatus can be found out by means of the convergent irradiation apparatus from a so-called fail bitmap, and the defective portion is worked in the next process.

The calculation function of charge 13 and the library function 15, which will be described hereinafter, are mounted on a host computer served for managing the network system 12. A charge system prepared based on the time required for analysis and the difficulty of operation, the type of rental equipments, and received service is set previously, the charge is calculated by means of the charge calculation function 13 connected to the network and transmitted to the customer on line for viewing the charge on the operation screen, and the customer constructs an operation request menu with consideration of the estimated charge.

The service includes the control of a plurality of types of apparatus, data acquisition, data interpretation, data analysis, Q&A, presentation of the data in the past for reference, maintenance management and maintenance work of the apparatus, and presentation of solution for semiconductor manufacturing.

In addition to the above, the charge system may include the contract in bulk such as time rental of apparatus and analysis expert and yearly maintenance contract not based on analysis request item to simplify the charging system. Finally, the bank 14 who has received a request to collect the charge from the charge calculation function 13 requests the customer 2 to pay the charge, and the charge is collected. Furthermore, the charge system includes the sending of a specimen and specification from the customer 2 to the analysis organization 1, the calculation of an estimate before analysis, the reporting the result to the customer though the network system 12.

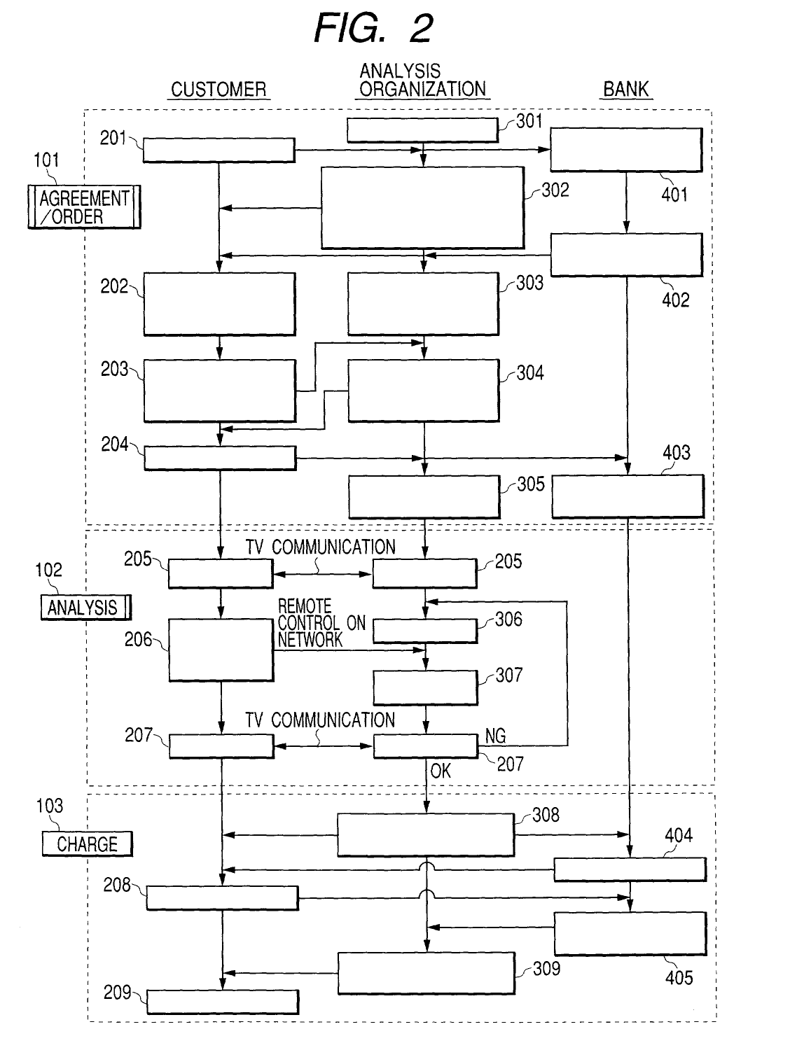

FIG. 2 shows an exemplary algorithm required for a series of processes including communication between the customer, analysis organization, and bank involving matters from agreement and order to actual analysis work and charging. Herein, the whole algorithm is grouped into agreement/order 101, analysis 102, and charge 103 for convenience of the description. Furthermore, in the algorithm, the activity content of the customer, analysis organization, and bank are arranged in the time series fashion.

The communication method through the Internet may be employed as a system that can be used by many unspecified customers. To realize such system, the analysis organization opens a Web site 301 to receive reservation 201 of contract from customers previously. After the arrival of the contract reservation 201 is confirmed on the website, the analysis organization requests the bank for opening bank account for analysis charge 401. Furthermore, the analysis organization sends to the customer things those are required to realize the communication between the analysis organization and the customer and those are related to remote specimen analysis, namely a monitor, TV camera, manual, registration, charge table relating to the whole contract 302. Furthermore, the bank sends notification of a bank account to the customer 402.

The customer initializes communication conditions of the Internet line 202, and the analysis organization also initializes communication condition 303. To secure the security of communication, the customer inputs the password assigned previously by the analysis organization when the customer activates the control screen. It is important to construct the system so that a third party who does not know the password cannot use the control monitor. After preparation of the analysis environment is completed as described hereinbefore, the customer selects a specimen to be evaluated, and sends the specimen and specification form that has been prepared to indicate the detail of the evaluation content 203.

Upon referring to the specimen and specification form, the analysis organization issues a rough cost estimation and sends a notification of date for analysis 304. After the customer confirms it, the customer issues a formal order 204, and the analysis organization issues a notification of serial number assigned to the received order 305. The bank issues a notification of serial number similarly so that the money is paid and received smoothly by using the common serial number used also by the bank 403.

Next, when the date for analysis comes, the customer and analysis organization communicate with each other according to the above-mentioned manual. The specification is discussed on video conference 205. The analysis organization carries out the analysis subjectively with aid of the instruction of the customer and participation by the customer by means of remote operation through the network 306. The customer selects, indicates, and corrects the desired analysis method and sends the information to the bank while the customer is cogitating the data obtained momentarily and is discussing the policy with taking part in analysis and with reference to library 206. The analysis organization reports the result 307, discusses on the data successively, and continues the discussion of the result on the video conference 207.

Because it is required to report the data promptly, the display on the network screen is used for reporting. Furthermore, the data is enciphered on the network from the view point of security of the data so that a third party who gets the data in the network by means of something cannot refer to the data.

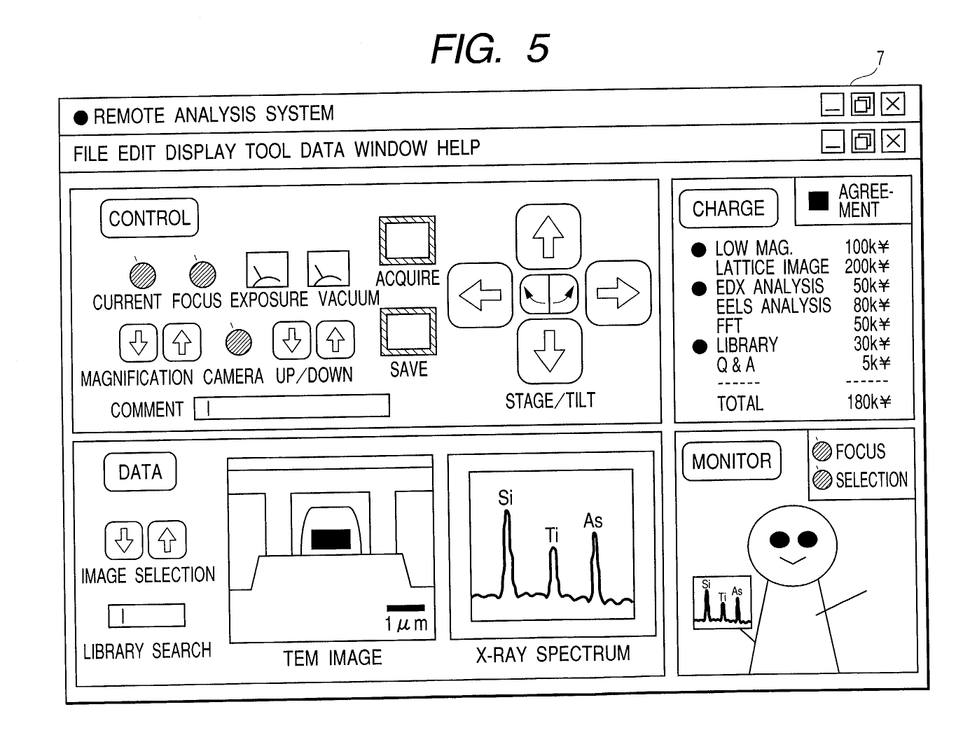

In the case that it is found that the data is problematic or insufficient as the result of the above-mentioned discussion on the result, the analysis should be repeated again, on the other hand in the case that the data is sufficient, the analysis is determined to be completed. When the analysis is completed, the analysis organization sends the calculation of charge and report to the customer and bank 308. The customer can monitor the charge always on the charge screen part of the operation screen shown in FIG. 5 that will be described in Embodiment 2, and it is desirable that the customer consults the analysis organization about the analysis and continues the analysis with selecting the analysis content so as to match with the budget of the customer. Therefore, the calculation of charge and report 308 are usually final. The final result may be transmitted on the communication screen or may be sent by mail.

The bank recognizes the result and sends a bill to the customer 404, and the customer pays the charge to the bank according to the bill 208. The bank subtracts the commission from the charge paid from the customer and pays the residual charge to bank account of the analysis organization 405. Upon receiving the residual charge, the analysis organization confirms that all of the work has been completed, and sends a notification of completion to the customer 309. The customer confirms the end 209 based on the notification. At that time, the customer usually returns various hardware/software that has been rented from the analysis organization 302.

Furthermore, the above-mentioned library function is served to refer to accumulated analysis data in the past so that the similar case is found and the same analysis is omitted, or the similar case can be used as the reference for constructing analysis procedure. Otherwise, the library function is always open as the Web site use function of the analysis organization in the day other than the date of analysis to the member who participates in the membership. The password should be introduced to clear the security problem, and the openable information is open on the library function with coordination by experts.

Embodiment 2

One example of the operation screen provided on the network computer 16 on the customer side in the analysis business described in Embodiment 1 is shown in FIG. 5. This is one example of “remote analysis system” file that is controlled by a Windows personal computer. The screen is divided into four parts, namely “operation screen” of the apparatus that is operated remotely, “result screen” for displaying the result, “charge screen” for monitoring accumulated charge amount obtained by consultation of the charge with reference to the check list, and “monitor screen” used for Q&A on the video conference and consultation on the apparatus operation and data interpretation.

“Operation screen” is provided with knobs, buttons, and instruments, and is operated with touch panel or clicking by a mouse. “Result screen” displays images and spectrum obtained though the analysis work, the past data retrieved from the library function, and various data presented by experts of the analysis organization.

In addition to the above, a staff of the analysis organization who accumulates much experience interprets and analyzes the obtained data, refers to the database of the staff, evaluates the data multilaterally by using a plurality of analysis apparatus depending on the case, and presents a solution that relates to the cause is found out. At that time, for example, the analysis staff presents his opinion in the form of “report” on “result screen”. In the case that a plurality of analysis apparatus are used, for example, “result screen” can be changed to a data screen of the target analysis apparatus by clicking a screen change button on “result screen”.

Furthermore, the charge table provided by the analysis organization is listed on “charge screen”, the charge is accumulated by marking a selected item, for example, marking a radio button added to the item when the analysis work item is selected with discussion between the analysis organization and the customer, and the total charge amount can be viewed easily. After the final accumulated estimation is completed, the customer clicks YES button to define the charge, another screen is then opened, and the bill address for payment to the bank and the bank account can be input.

“Monitor screen” is a screen served for showing similitude of both sides obtained by using the camera 8 and served for showing the data. In this “monitor screen”, buttons used for focusing and zooming of the camera 8, and, in the case that a plurality of cameras are provided, a button for switching the camera are provided.

The apparatus control screen, data display screen, charge confirming screen, and video conference monitor screen are displayed dividedly on the control screen of the network computer as described herein above. Otherwise, an arbitrary screen may be displayed selectively from among these sub-screens as required.

Embodiment 3

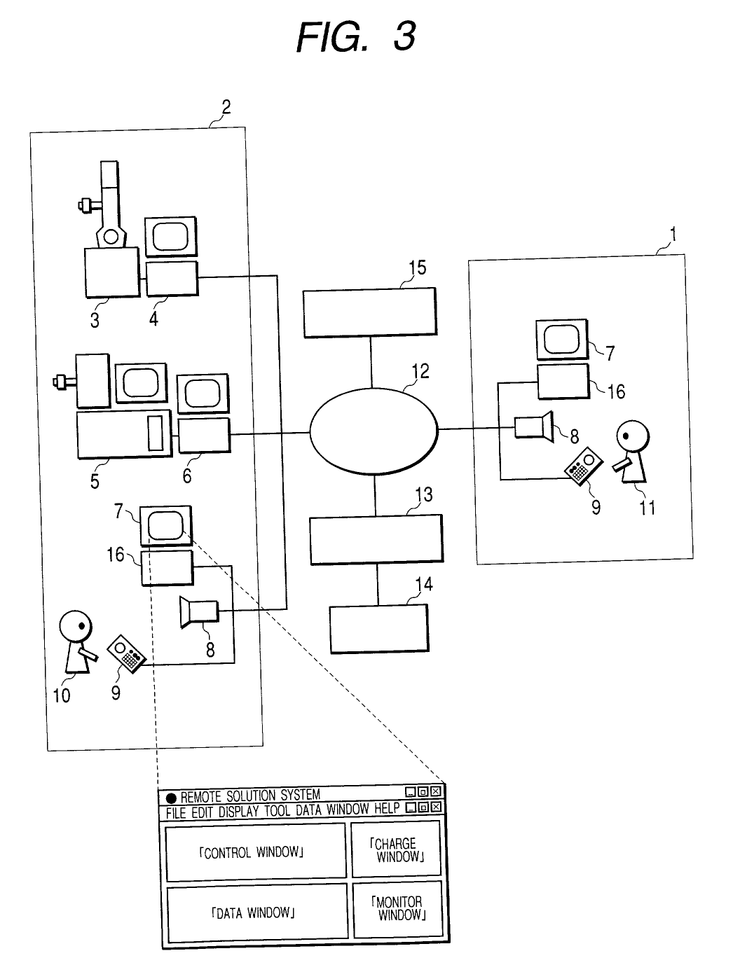

FIG. 3 shows an example in which the customer 2 has various apparatus and the analysis organization 1 proves operation and maintenance service through the network for analysis working.

In this case, in the service includes professional action required for apparatus operation such as wide range consultation on specimen preparation and pre-treatment before analysis, apparatus adjustment, maintenance, vacuum monitor, beam intensity adjustment, supplement of liquid nitrogen, warming up before analysis work, flushing of a cold cathode field emission electron gun, apparatus operation and data analysis, and Q&A on interpretation, in addition to obtaining and supplying analysis data. As in the case of Embodiment 1, these operations should be computerized, and the computerization has been realized currently for almost all the items technically.

The control and communication command used in the network system 12 are rendered common for the whole system so that many customers 2 can use various analysis apparatus of a plurality of analysis organizations 1 without limiting the customer 2 and analysis organization 1 to one-to-one relation. Thereby, analysis procedure that an analysis organization does not have can be used.

A large memory area, namely a library function, is secured on the network system 12, a customer can load and can view the data. The system is constructed so as to provide many reference data as described hereinabove. Thereby, a customer 2 can save the work for data collection with reference to analysis examples in the past. As the result, the time and cost are reduced.

The library use charge is charged depending on the time and secrecy of the data. When a customer 2 wants to use the library function, the customer is requested to show the password or registration number to prevent use and quotation of the library by the general public, and the intellectual property is protected. Similarly, it may be possible that a customer cannot copy the data easily by locking the data previously.

In the present invention, the collected data is collated with the data of the library function, and the high level information is extracted by consulting with interpretation and analysis by experts as described hereinabove.

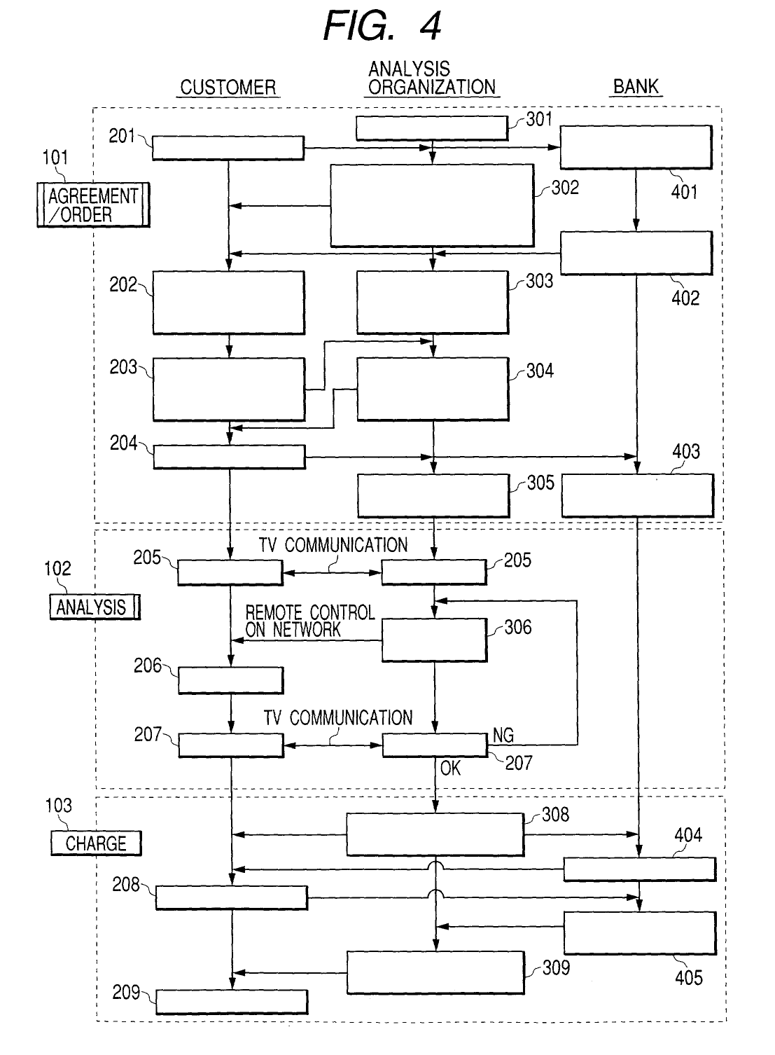

FIG. 4 shows an exemplary algorithm that is required for a series of processes including communication between a customer, analysis organization, and bank from agreement/order to actual analysis work, and charging. Herein, the whole algorithm is grouped into agreement/order 101, analysis 102, and charge 103 for the purpose of convenience.

In the agreement/order 101, the algorithm shown in FIG. 2 is different from the algorithm shown in FIG. 4 in that the specimen and specification form are sent together in the former 203, but only the specification form is sent in the latter 210. The reason is that the apparatus is installed on the customer side, and the customer sets a specimen in the analysis apparatus.

In the analysis 102, the specification is discussed on the Video conference at first 205. Next, the analysis organization performs the analysis and maintenance of the apparatus 310. Herein also, the analysis organization side that is skilled in analysis mainly operates the apparatus of the customer by means of remote operation through the network. The customer examines the data obtained successively by taking part in analysis and referring to the library 206, and selects, indicates, and corrects the desired analysis procedure to the bank with discussing the selection as in the case of Example 1. Similar to the discussion of the result 207 on video conference, in the case of this example, the analysis organization performs the apparatus maintenance work and also concomitant consultation 311. In other words, it is important to give advice about maintenance and analysis operation so that the customer brings out the performance of the apparatus. When the analysis work 102 is completed, the sequence proceeds to the charge 103. The above-mentioned flow is the same as that of Embodiment 1.

The above-mentioned example is an example in which the customer 2 has the apparatus, and the above-mentioned business model is realized even though not only in the case that the apparatus is owned by the customer 2 but also in the case that the apparatus is an apparatus leased from the analysis organization 1 or from an analysis apparatus maker not shown in the drawing. The leased apparatus contributes to the customer so that the financial load on the customer is mitigated. The saved money can be used for the analysis, or used to increase the number of types of apparatus or number of apparatus advantageously. Therefore, the analysis organization bills the customer for the lease charge in addition to the remote operation and maintenance, and consultant charge. At that time, the operation screen can be used commonly shown in FIG. 5.

As described hereinabove, it is possible to realize diversified analysis by use of the apparatus that is not owned by one party in the present invention.

embodiment 4

A detailed example of consultation described in the above-mentioned example will be described. For example, an example in which a high resolution pattern is obtained by use of an electron microscope is shown. The lattice interval of a high resolution pattern (lattice pattern) is different depending on the thickness of a specimen and focus condition. Therefore, an atom arrangement model cannot be compared with the obtained image simply. In this case, it is required that the obtained image is verified and interpreted by use of the simulation in which an atom arrangement model and electron optical system are assumed. The technique to do this operation requires high level technique, it is effective that an image obtained by the analysis organization is interpreted, and the interpretation is fed back to the customer. For the same purpose, it is possible that the high resolution pattern (lattice pattern) is subjected to Fourier transformation, the pattern image that shows the periodical structure and the database of electron diffraction image are compared to thereby identify the crystal structure, lattice spacing, strain and defect, dislocation, and material.

Furthermore, when an electron beam is irradiated on a specimen, characteristic X-ray that penetrates the specimen is generated and the energy loss characteristic caused from the material is exhibited. Thereby, material on the area where an electron beam is irradiated can be identified or bonding between atoms can be examined. In general, the spectrum data includes not only the signal from the target material but also various background. For example, the background includes the continuous background such as the system peak and damping X-ray generated from the material that forms the apparatus. In addition, if some materials are contained in a specimen, tails of adjacent peaks forms the background of each peak.

In such case, it is required that the background should be subtracted from the original obtained data, and the data conversion is required when the element composition is quantified from the peak intensity. Conventionally, the result is derived relying on the analysis software entirely because such processing is very difficult for a beginner in general, the reliability of the data is poor because the result is different depending on the thickness of a specimen and the apparatus condition. In such case, the precise analysis by an expert is very important, and the consultation with an expert through the network for analysis is advantageous to derive the result.

Embodiment 5

The analysis that is requested to an expert is effective to derive the useful information from the measured data as described hereinabove. For example, recently the increase of internal stress of silicon crystal and concomitant failure are revealed as a problem concomitantly with minimization and introduction of new material and new structure in the advanced semiconductor device development, the understanding of the phenomenon based on the actual measurement and establishment of stress reduction process become urgent subject. In this case, because the amount of the stress is very small and stress is located on a very small area, it is difficult to clarify the specimen preparation, measurement, analysis, and interpretation. Therefore the solution involving the consultation with an expert as described in the present invention can be very effective.

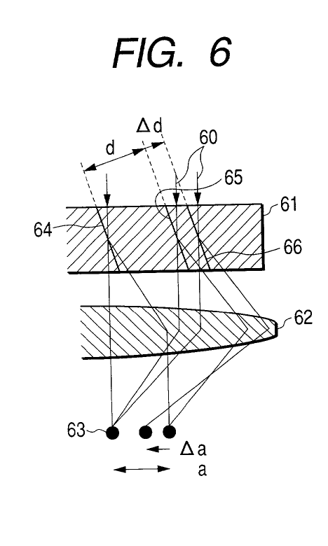

An example in which two-dimensional stress distribution of a semiconductor device is analyzed based on the measurement and analysis of an electron diffraction image of a transmission electron microscope (TEM) will be described. At first, a method for measuring the strain and stress of a crystal are measured from a diffraction image by use of FIG. 6.

An electron beam 60 is incident to a specimen 61, and the electron beam is diffracted on the crystal lattice. It is assumed that the crystal lattice (a) 64 and crystal lattice (b) 65 have no strain, and the crystal lattice (b) 65 is moved to the strained crystal lattice 66 due to the generation of a strain caused by a stress. Electron beams diffracted each crystal lattice are refracted by an electron lens 62, and a diffraction pattern 63 is formed as the result.

It is assumed that the distance between diffraction points of a diffraction pattern having no strain is a. The crystal lattice spacing d is inversely proportional to the distance between diffraction points a. Therefore, the displacement of the distance between diffraction points is denoted as Δa, then the relation of the lattice strain Δd/d=Δa/a holds. Furthermore, because the stress P is a value formed by multiplying the displacement and the elastic constant k that is a proportional coefficient inherent to the type of material and crystal plane together, then P=k·Δd/d=k·Δa/a. Therefore, it is understandable that the displacement and stress can be measured from a diffraction pattern.

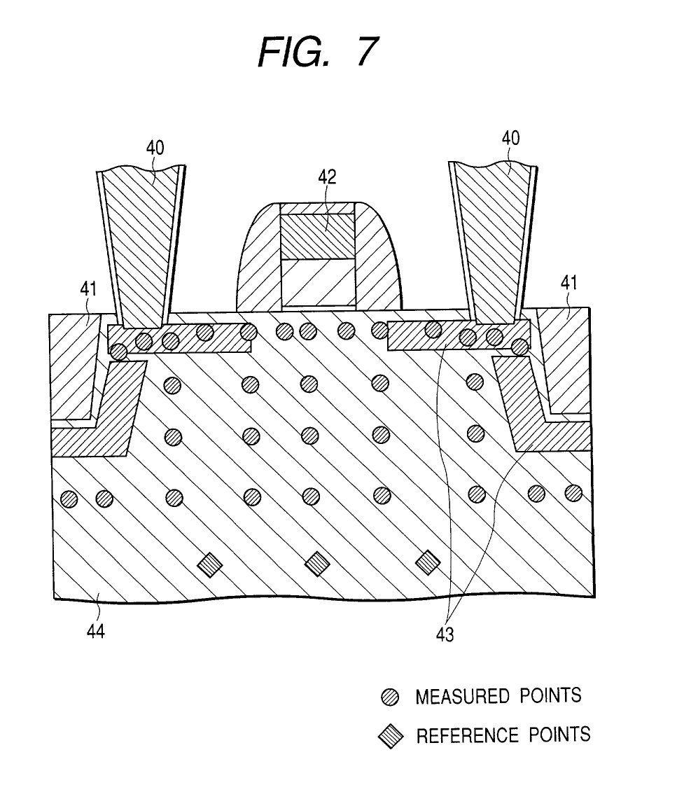

A transmission electron microscope irradiates an electron beam that is converged to a beam having a diameter of 10 nm or smaller, and a diffraction pattern as shown in FIG. 6 is observed. A specimen that is observed from the cross section direction of a transistor to be observed is prepared by means of a specimen preparation method used generally such as FIB (Focused Ion Beam) as shown in FIG. 7.

In the case of a typical transistor, plugs 40 and a gate 42 are formed on an area located between element separation layers 41 on a silicon substrate 44, and the portion 43 where the stress is caused is strained in many cases. In this case, silicon lattice of the deep portion of the substrate remains in original state generally, and the diffraction pattern is obtained by irradiating an electron beam on a plurality of measurement points as shown in FIG. 7 with referring to the deep portion as the reference point of the lattice interval.

Next, measurement is carried out at the measurement points shown in FIG. 7, and the displacement of lattice interval is calculated with respect to that of the lattice interval. At that time, an enlarged pattern that shows the specimen structure including the measurement point is obtained.

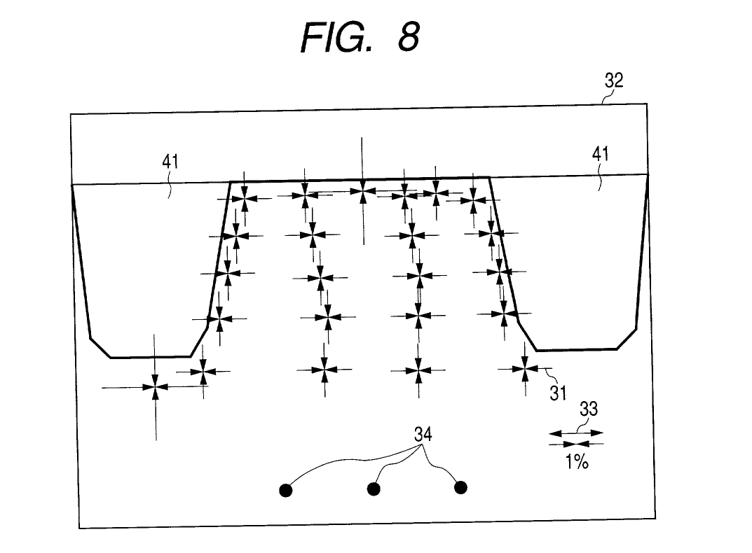

The displacement of lattice interval, namely the quantified strain amount, is displayed on the enlarged pattern obtained as described hereinabove as shown in FIG. 8. The arrow for indicating strain amount 31 having a length that is proportional to the amount of strain is written on the structure image 32. Herein, the relation between the length of an arrow and the strain amount is represented by a scale bar 33. Herein, as shown in FIG. 8, arrows directed in the parallel direction and perpendicular direction of the substrate are crossed, and the cross point shows the position where an electron beam was irradiated. Furthermore, a pair of arrows directed opposite each other indicates the compression strain, and a pair of arrows directed so as to depart each other indicates the tensile strain.

On the structure image 82, the reference point 34 is also marked. Furthermore, because the strain and the stress are in a proportional relation, the arrow length can represent the stress amount. In this case, the scale bar should define the stress amount. The display type of the result may be other display type. For example, based on the data shown in FIG. 8, a method in which points having the equal strain or stress are connected with the contour line, or a method in which the stress value is shown with color code may be used effectively.

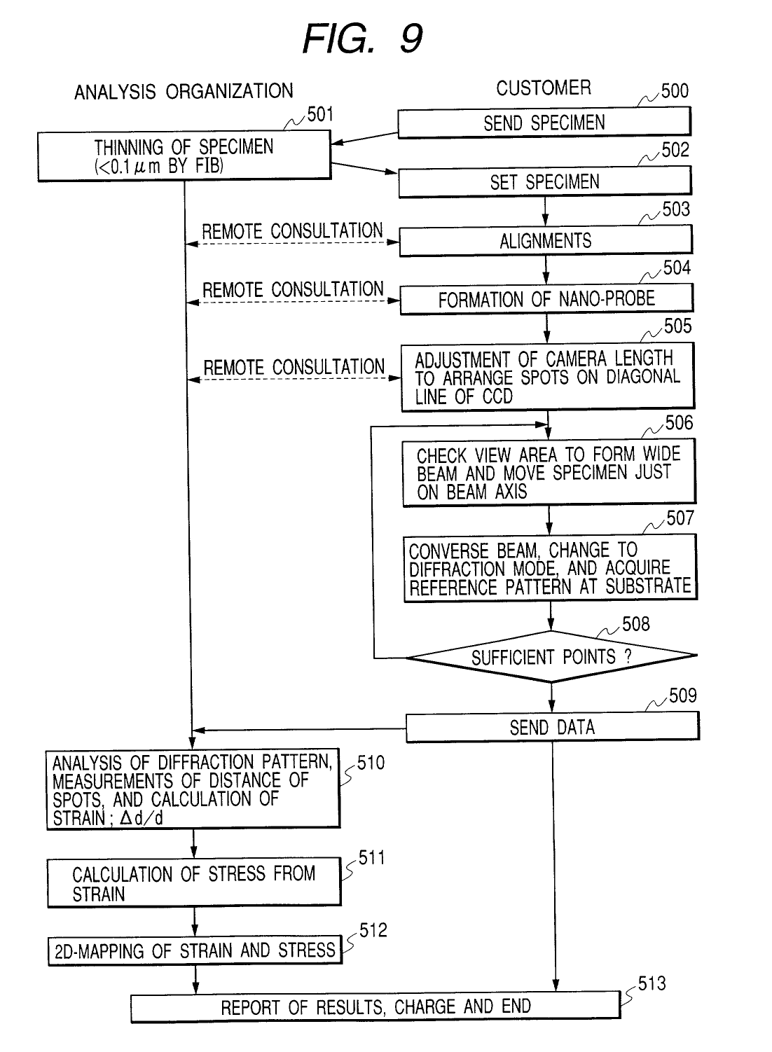

Because the stress analysis requires considerably complex processing as described hereinabove, the cooperation with an expert through the network as described in the present invention is very effective. One example of a method for carrying out the work is described referring to a flowchart shown in FIG. 9.

In the case of evaluation by use of a TEM, at first it is required to slice a specimen. Because high precision slicing technique is required to take out the specified failure portion of a semiconductor device, for example, a specimen is sent from a customer to an analysis organization as shown in the procedure 500. The specimen is sliced to form a piece having a thickness of 0.1 μm or thicker by means of ion beam technique as shown in the procedure 501. The thicker specimen is desirable from the viewpoint of stress relaxation of in the specimen preparation, and it is required that the thickness of specimens should be equalized precisely in the case the stress value is compared between a plurality of specimens. The high precision specimen thickness control is important. The prepared specimen is sent again to the customer, the specimen is set on the stage of an electron microscope as shown in the procedure 502, and the orientation is adjusted so that an electron beam is incident in parallel strictly to the lattice plane as shown in the procedure 503.

Next, the diffraction pattern is imaged. It has been found that the unbalance of the diffraction point intensity is caused if the specimen is inclined and the precision of the measurement of the distance between diffraction points becomes poor resultantly, and the orientation adjustment is essentially required to prevent the inclination. A nano-probe electron beam having a very small diameter that is irradiated in parallel as shown in the procedure 504 is formed, a diffraction pattern having a size that matches with the light receiving area of a focused camera is formed by adjusting a projection lens, and the diffraction pattern is focused on a pixel detector such as CCD as shown in the procedure 505. It is desirable that the diffraction points are apart each other as far as possible on the light receiving screen to measure the distance between diffraction points accurately. For example, when a diffraction pattern is photographed by use of CCD having a square light receiving screen, the specimen is turned, the diffraction pattern is turned by adjusting the projection lens, or the pixel detector is turned so that a pair of diffraction points for measuring of the interval are arranged on the diagonal line of the light receiving screen.

After the diffraction pattern has been photographed by means of nano-diffraction technique as described hereinabove, the irradiation condition on the specimen is changed to form a wide electron beam and the field of view is confirmed on the enlarged pattern of TEM, and then a measurement point is sought as shown in the procedure 506. At that time, the relative position between the crystal specimen and the electron beam is changed. The electron beam may be moved to the target field of view position, but it is desirable that the field of view is moved on the electron beam path with the stage to thereby prevent the diffraction pattern from being strained. As shown in the procedure 507, the electron beam is converged, and a diffraction pattern (Diff. image) is photographed as the reference of the diffraction pattern at, for example, the deep portion of the substrate, where the strain and stress are considered to be zero.

The enlarged pattern and the diffraction pattern are switched alternately and observed repeatedly as described hereinabove, and the number of target points is satisfied as shown in the procedure 508. Thereafter, as shown in the procedure 509, the data is sent from the customer to the analysis organization. The analysis organization analyzes the acquired diffraction pattern and proceeds to the step in which the characteristics of the crystal, namely the strain and stress, is determined.

At first, as shown in the procedure 510, the target distance between diffraction points is measured, and the deviation from the reference value is determined to calculate the strain amount Δd/d. Next, as shown in the procedure 511, the stress is calculated by multiplying the elastic constant that is different for each element, crystal structure, and crystal plane and the strain amount together. For example, the elastic constant k=1300 MPa in the case of silicon (220) plane, and the elastic constant k=1700 MPa in the case of silicon (002) plane. In detail, in the case that the diffraction point of silicon (220) plane shifts 0.1%, it is found that the stress is 130 MPa. Finally, as shown in the procedure 512, the two-dimensional distribution of the strain and stress is visualized. Thereafter, as shown in the procedure 513, the result is reported to the customer, the charging is confirmed finally, and the work is brought to an end.

The procedures 503, 504, and 505 in the series of evaluation work as described hereinabove involve difficult adjustment work, and the support by the analysis organization through the network allows such difficult work to be realized. Furthermore, the analysis organization may directly adjust the apparatus installed on the customer side through the network.

Furthermore, because the analysis on the acquired data is highly difficult, herein the result is sent from the customer to the analysis organization. In other words, the analysis organization takes a part of analysis and whole display. In this case, as a matter of course, the charge dependent on the difficulty and the work load is charged to the customer.

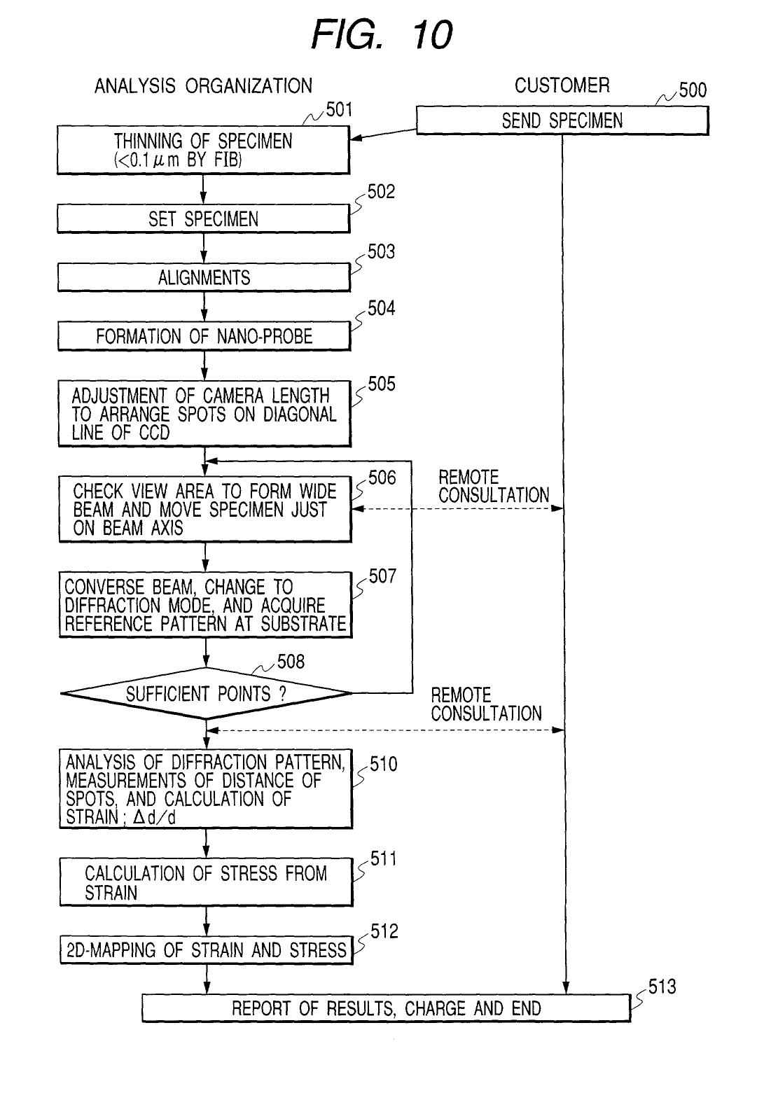

The customer can rely on the analysis organization for high level analysis and pattern processing including measurement and analysis as described in this example. In such case, the sequence is shown in a flowchart of FIG. 10.

In detail, the customer sends a specimen to the analysis organization in the procedure 500. The specimen is sliced to form a thin film having a thickness of 0.1 μm or thicker by means of ion beam technique as shown in the procedure 501. Thereafter, the thin film specimen is set in the apparatus of the analysis organization as shown in the procedure 502 without sending back to the specimen to the customer differently from the example shown in FIG. 9. The process from the procedure 503 to the procedure 508 is different from the case of the example shown FIG. 9 in which the customer works by itself under consultation with the analysis organization in that the analysis organization works under consultation with the customer arbitrarily in the embodiment shown in FIG. 10.

After the measurement of the sufficient number of target specimens has been completed in the procedure 508, the analysis organization works on the procedure 510 to the procedure 512 continuously. Finally in the procedure 513, the analysis organization reports the result to the customer and confirms the final charge in the procedure, and the analysis work is brought to an end.

The charge is defined dividedly depending on the quality and the quantity of received service. For example, the charge is different depending on the number of analysis points and number of diagrams to be analyzed shown in FIG. 7. The charge for the case that the customer mainly carries out the work according to the flow shown in FIG. 9 is higher than the charge for the case that the analysis organization mainly carries out the work according to the flow shown in FIG. 10. Additionally, the charge is different depending on the difficulty of sampling, the number of consultation, the number of use of the database, type of used analysis apparatus, connection time to the network in day time or night time, and the degree of skill of an expert who is engaged in the analysis. The charge system is confirmed by referring to “charge screen” shown in FIG. 5.

The present invention is summarized as described in the following.

1) A network solution analysis method characterized by comprising, in the state that a plurality of analysis apparatus of an analysis organization and a plural of customers are connected with a network, a step in which the analysis organization acquires the data by remotely controlling the analysis apparatus, a step in which a control software is provided so that a customer confirms the charge for the service content and the acquired data received from the analysis organization on the control screen of the network computer, and the customer participates to the apparatus control, a step in which the analysis organization presents an answering document to the customer through the network, and a step in which the expense paid by the customer corresponding to the charge for the analysis result is collected from a bank.

2) A network solution analysis method characterized by comprising, in the state that a plurality of analysis apparatus of an customer and an analysis organization are connected with a network, a step in which a control software is provided so that a customer confirms the charge for the service content and the acquired data received from the analysis organization on the control screen of the network computer, and the customer participates to the apparatus control, a step in which the analysis organization presents an answering document to the customer through the network, and a step in which the expense paid by the customer corresponding to the charge is collected from a bank.

3) A network solution analysis method characterized in that the on-line meeting is made possible between the analysis organization and the customer by transmitting a signal of television cameras installed on both parties in the structure as described in 1) or 2).

4) A network solution analysis method characterized in that the service content provided to the customer includes the apparatus control of a plurality of apparatus types, data acquisition, data interpretation, data analysis, Q&A, presentation of the past data for reference, operation and maintenance work of the apparatus, and solution for semiconductor production in the structure as described in 1) or 2).

5) A network solution analysis method characterized in that the apparatus control screen, data display screen, charge conforming screen, and video conference monitor screen are displayed dividedly or some arbitrary screens selected from among these screens are displayed on the control screen in the structure as described 1) or 2).

6) A network solution analysis method characterized in that the analysis apparatus includes an electron microscope, mass spectrometer, photoelectron spectrometer, probe microscope, Auger spectrometer, magnetic resonance spectrometer, semiconductor inspection apparatus, chromatography, DNA sequencer, blood analysis apparatus, chemical analysis apparatus, biochemical inspection apparatus, convergent ion irradiation apparatus, plasma cleaner, specimen preparation apparatus, specimen pre-treatment apparatus, personal computer, scanner, image processing apparatus, data processing apparatus, hard disk, and memory medium apparatus in the structure as described in 1) or 2).

7) A network solution analysis method characterized in that the remote apparatus control includes specimen preparation before measurement/pre-treatment, putting or taking of a specimen in or out from an apparatus, vacuum exhaust, acceleration voltage application, beaming, preliminary adjustment/optical axis adjustment, focus correction, astigmatism correction, specimen slight movement/inclination, data photographing/acquisition, storage and maintenance of data, and print out of data in the structure as described in 1) or 2).

8) A network solution analysis method characterized in that the network has a library function having a memory area that stores the past data and discloses the analysis data in response to a request from the customer in the structure as described in 1) or 2).

9) A network solution analysis method characterized in that the library function has a library managing function so that the input of a password or registration number should be entered from the network computer of the customer to use the library in the structure as described in 8).

10) A network solution analysis method characterized in that the operation and maintenance work of the apparatus includes vacuum degree monitor, beam amount adjustment, liquid nitrogen supplement, warming up before analysis work, and flashing of cold cathode field emission electron gun in the structure as described in 1) or 2).

11) A network solution analysis method characterized in that the remote apparatus control is carried out by use of an operation console provided exclusively for the customer or an exclusive control software installed in the network computer in the structure as described in 1) or 2).

12) A network solution analysis method characterized in that the analysis apparatus of the customer is an apparatus that is rented from the analysis organization, analysis apparatus company, or bank, and the rental charge is paid to the analysis organization, analysis apparatus company, or bank in the structure as described in 1) or 2).

13) A network solution analysis method characterized in that the answering document comprises a step for adding the interpretation and analysis result to the acquired data, for mentioning the related data obtained from the library function, and for additionally presenting the result obtained by use of another analysis apparatus in the structure as described in 1) or 2).

14) A network solution analysis method characterized in that the data acquisition step includes a process in which failure portion of a wafer or chip is sought by use of a semiconductor inspection apparatus or convergent ion irradiation apparatus, the failure portion is picked out by use of the convergent ion irradiation apparatus and analyzed by use of an analysis apparatus in the structure as described in 1) or 2).

15) A network solution analysis method for measuring the stress distribution of a specimen from a diffraction pattern obtained by irradiating a charged particle beam onto the specimen characterized by comprising a step in which a customer and an analysis organization are connected to a network through a communication line, the customer acquires the measurement data including the diffraction pattern of the specimen with receiving the technical service from the analysis organization through a network computer, and sends the measurement data to the analysis organization, a step in which the analysis organization analyzes the measurement data including the diffraction pattern of the specimen to measure the stress distribution, and reports the result to the customer, and a step in which the customer confirms the report including the measurement result supplied from the analysis organization.

16) A network solution analysis method for measuring the stress distribution of a specimen from a diffraction pattern obtained by irradiating a charged particle beam onto the specimen characterized by comprising a step in which a customer and an analysis organization are connected to a network through a communication line, the analysis organization acquires the measurement data including the diffraction pattern of the specimen according to the order received from the customer with discussion each other through the network, analyzes the measurement data including the diffraction pattern of the specimen to measure the stress distribution, and reports the result to the customer, and a step in which the customer confirms the report including the measurement result supplied from the analysis organization. 17) A network solution analysis method for the process to measure the stress distribution of a semiconductor device from an electron diffraction pattern of a transmission electron microscope characterized by comprising a step in which a customer and an analysis organization are connected each other to a network through a communication line, the analysis organization receives a specimen sent from the customer, acquires the measurement data including the diffraction pattern of the specimen with discussion each other through the network computer, analyzes the measurement data including the diffraction pattern of the specimen to measure the stress distribution, and reports the result to the customer, and a step in which the customer confirms the result report supplied from the analysis organization, and confirms the charge corresponding to the service content provided from the analysis organization on the screen of the network computer.

18) A network solution analysis method for the process to measure the two-dimensional stress distribution of a specimen from a diffraction pattern obtained by irradiating a charged particle beam onto the specimen characterized by comprising a step in which a customer and an analysis organization are connected each other to a network through a communication line, the customer acquires the measurement data including the diffraction pattern of the specimen with receiving the technical service from the analysis organization through the network computer, and sends the measurement data to the analysis organization, a step in which the analysis organization analyzes the measurement data including the diffraction pattern of the specimen to measure the two-dimensional stress distribution, and reports the result to the customer, and a step in which the customer confirms the result report and the charge corresponding to the service content sent from the analysis organization.

19) A network solution analysis method for the process to measure the two-dimensional stress distribution of a specimen from a diffraction pattern obtained by irradiating a charged particle beam onto the specimen characterized by comprising a step in which a customer and an analysis organization are connected to a network through a communication line, the analysis organization acquires the measurement data including the diffraction pattern of the specimen according to the order received from the customer with discussion each other through the network, analyzes the measurement data including the diffraction pattern of the specimen to measure the two-dimensional stress distribution, and reports the result to the customer, and a step in which the customer confirms the report including the measurement result and the charge corresponding to the service content sent from the analysis organization.

The present invention is useful to reduce the cost and time necessary for analysis by means of a method in which the apparatus and operation expert technique are used commonly by a customer and an analysis organization.

What is claimed is:

1. A network solution analysis method in which a customer, a specimen analysis organization, and specimen analysis apparatus are connected to a network through a communication line, the specimen analysis organization acquires the measurement data by controlling the specimen analysis apparatus according to an order from the customer, the customer confirms the acquired measurement data received from the specimen analysis organization and the charge corresponding to the service content through a network computer, and the customer participates in the analysis work cooperatively with the specimen analysis organization.

2. A network solution analysis method comprising a step in which the specimen analysis organization acquires the measurement data by controlling the specimen analysis apparatus of the customer or the specimen analysis organization according to the order from the customer, a step in which the customer confirms the charge corresponding to the acquired measurement data and concomitant service content received from the specimen organization through the network, and participates in the analysis work cooperatively with the specimen analysis organization, and a step in which the specimen analysis organization presents the analysis result to the customer, wherein the network is connected to the customer, the specimen analysis organization, and the specimen analysis apparatus through a communication line.

3. The network solution analysis method as claimed in claim 1, wherein the network solution analysis method comprises a step in which the specimen analysis organization provides the operation of the specimen analysis apparatus, the work for maintenance of the apparatus, and the interpretation and analysis of the acquired measurement data to the customer through the network.

4. The network solution analysis method as claimed in claim 1, wherein the network solution analysis method comprises a step in which the specimen analysis organization collects the charge for the analysis result that the customer has confirmed and has paid to the bank correspondingly to the confirmation through the network.

5. The network solution analysis method as claimed in claim 1, wherein an apparatus control screen, measurement data display screen, charge screen, and monitor screen are displayed dividedly or arbitrary screens selected from among these screens are displayed on the screen of the network computer.

6. A network solution analysis system comprising a specimen analysis apparatus owned by a customer or a specimen analysis organization, a means for obtaining the measurement data that the specimen analysis organization acquires by controlling the specimen analysis apparatus according to the order received from the customer, and a computer having a function that the customer receives the acquired measurement data and the charge corresponding to the service content for the analysis work from the specimen analysis organization, and the measurement data and the charge are displayed on a screen of the computer, wherein the customer, the specimen analysis organization, and the specimen analysis apparatus are connected to a network through a communication line, and the analysis work is carried out through the network.

7. The network solution analysis system as claimed in claim 6, wherein the network is provided with a memory area, and a library function that accumulates the analysis data in the past in the memory area and discloses the analysis data in response to the request from the customer.

8. A network solution analysis method used in the process for measuring the stress distribution of a specimen from a diffraction pattern obtained by irradiation of a charged particle beam onto the specimen comprising a step in which a customer and analysis organization are connected to a network through a communication line, the customer acquires the measurement data including a diffraction pattern of a specimen with receiving the technical service from the analysis organization through a network computer, and the measurement data is sent to the analysis organization, a step in which the analysis organization analyzes the measurement data including the diffraction pattern of the specimen to measure the stress distribution, and reports the result to the customer, and a step in which the customer confirms the report including the measurement result supplied from the analysis organization.

9. A network solution analysis method used to measure the stress distribution of a specimen from a diffraction pattern obtained by irradiation of a charged particle beam onto the specimen comprising a step in which a customer and an analysis organization are connected to a network through a communication line, the analysis organization acquires the measurement data including a diffraction pattern of the specimen with discussion with the customer through the network, analyzes the measurement data including the diffraction pattern of the specimen to measure the stress distribution, and reports the result to the customer, and a step in which the customer confirms the report including the measurement result supplied from the analysis organization.

10. A network solution analysis method used to measure the stress distribution of a semiconductor device from an electron diffraction pattern acquired by use of a transmission electron microscope comprising a step in which a customer and an analysis organization are connected to a network through a communication line, the analysis organization receives a specimen from the customer and acquires the measurement data including the diffraction pattern of the specimen with discussion with the customer each other through the network computer, and the analysis organization analyzes the measurement data including the diffraction pattern of the specimen to measure the stress distribution and reports the result to the customer, and a step in which the customer confirms the result report supplied from the analysis organization, and confirms the charge for the service content supplied from the analysis organization through the screen of the network computer.
